(19) United States
(12) Patent Application Publication
(10) Pub. No.: US 2025/0273791 A1
(43) Pub. Date: Aug. 28, 2025

(54) POWER SUPPLY DEVICE

(71) Applicant: TOYOTA JIDOSHA KABUSHIKI KAISHA, Aichi-ken (JP)

(72) Inventor: Toshio UCHIYAMA, Toyota-shi (JP)

(21) Appl. No.: 19/051,175

(22) Filed: Feb. 12, 2025

(30) Foreign Application Priority Data
Feb. 27, 2024 (JP) 2024-027809

(51) Int. Cl. H01M 50/242; H01M 50/204; H01M 50/271

(52) U.S. Cl. CPC H01M 50/242; H01M 50/204; H01M 50/271

(57) ABSTRACT

A power supply device includes a housing including an upper case and a lower case, and a plurality of storage batteries housed in the housing. The lower case includes a side wall portion configuring an outer periphery of the lower case, an attachment portion that is provided at an upper side of the side wall portion, and that is attachable to the upper case in a state in which the upper case is disposed at an upper side relative to a bottom surface of the storage batteries, and a thick-walled portion protruding toward an outer side of the lower case at a boundary portion between the side wall portion and the attachment portion.

### CROSS-REFERENCE TO RELATED APPLICATION

This application is based on and claims priority under 35 USC 119 from Japanese Patent Application No. 2024-027809 filed on Feb. 27, 2024, the disclosure of which is incorporated by reference herein.

### BACKGROUND

### Technical Field

The present disclosure relates to a power supply device.

### Related Art

Japanese Patent Application Laid-open (JP-A) No. 2017-010835 discloses an invention related to a battery pack. In this battery pack, plural battery modules are stacked in the height direction inside a tray, and plural protrusions are provided on the lower wall part of a case configuring the outer shell of an upper battery module. These protrusions are engaged with the upper wall part of a case configuring the outer shell of a lower battery module. Therefore, in the invention according to JP-A No. 2017-010835, when the battery module moves owing to inertia during a vehicle collision, as a result of the protrusions colliding with the case, the impact load can be received by the protrusions.

In the foregoing prior art, it is assumed that a battery pack is installed in a vehicle; however, when installing the battery pack outdoors as a power source for a building, it is conceivable that impact loads from flying objects during rough weather such as a typhoon, for example, will affect the battery module.

Specifically, in the foregoing prior art, since the thickness of the case is uniform, when an impact load from a flying object or the like is input to the case, it is conceivable that rainwater or the like will enter into the inside of the case owing to stress being concentrated at a boundary portion between the lower wall portion and the side wall portion of the case and cracks being generated.

However, the above-mentioned prior art document does not refer to measures against impact loads from flying objects during rough weather such as a typhoon.

### SUMMARY

The present disclosure provides a power supply device capable of reducing the influence on a storage battery of an impact load caused by a flying object or the like in rough weather such as a typhoon.

A power supply device according to a first aspect includes: a housing including an upper case and a lower case; and plural storage batteries housed in the housing, the lower case including: a side wall portion configuring an outer periphery of the lower case; an attachment portion that is provided at an upper side of the side wall portion, and that is attachable to the upper case in a state in which the upper case is disposed at an upper side relative to a bottom surface of the storage batteries; and a thick-walled portion protruding toward an outer side of the lower case at a boundary portion between the side wall portion and the attachment portion.

According to the power supply device of the first aspect, plural storage batteries are stored inside a housing provided with an upper case and a lower case.

Incidentally, when the housing is installed outdoors, it is conceivable that an impact load from a flying object or the like during rough weather such as a typhoon will be input to the lower case. At this time, if the thickness of the lower case is uniform, it is conceivable that stress will be concentrated at a boundary portion between a lower wall portion and a side wall portion of the lower case, whereby cracks will be generated, and rainwater or the like will enter the inside of the lower case via the cracks.

In this aspect, the lower case includes a side wall portion configuring an outer periphery and an attachment portion provided at an upper side of the side wall portion. Further, the upper case is attached to the attachment portion in a state of being disposed at an upper side relative to the bottom surface of the storage batteries.

Further, a thick-walled portion that protrudes toward the outside of the lower case is provided at a boundary portion between the side wall portion and the attachment portion.

For this reason, in this aspect, when an impact load from a flying object or the like during rough weather such as a typhoon is input to the lower case, stress tends to concentrate at the boundary portion between the side wall portion and the thick-walled portion. As a result, the reliability with which the side wall portion of the lower case will deform at an upper side relative to the bottom surface of the storage battery as a result of the impact load is improved, and ingress of rainwater or the like into the inside of the lower case via cracks in the lower case caused by the impact load can be suppressed.

A power supply device according to a second aspect is the power supply device according to the first aspect, in which the side wall portion inclines toward the outer side of the lower case on progression toward the upper case.

According to the power supply device of the second aspect, the side wall portion of the lower case inclines toward the outer side of the lower case on progression toward the upper case. For this reason, distance between the thick-walled portion provided in the lower case and the storage battery is secured, and it is possible to suppress contact between the lower case and the storage battery when the vicinity of the thick-walled portion of the lower case is deformed owing to an impact load caused by a flying object or the like.

A power supply device according to a third aspect is the power supply device according to the first aspect or the second aspect, in which the attachment portion includes a flange portion extending toward the outer side of the lower case from a peripheral edge portion at an upper side of the side wall portion, the thick-walled portion is provided along the peripheral edge portion, and a portion at which the thick-walled portion is provided is the thickest portion of the lower case.

As described above, the power supply device according to the present disclosure has the effect that the influence on a storage battery of an impact load caused by a flying object or the like in rough weather such as a typhoon, can be reduced.

### BRIEF DESCRIPTION OF THE DRAWINGS

An exemplary embodiment of the present disclosure will be described in detail based on the following figures, wherein:

FIG. 1 is a cross-sectional view schematically showing the configuration of a power supply device according to the present embodiment.

### DETAILED DESCRIPTION

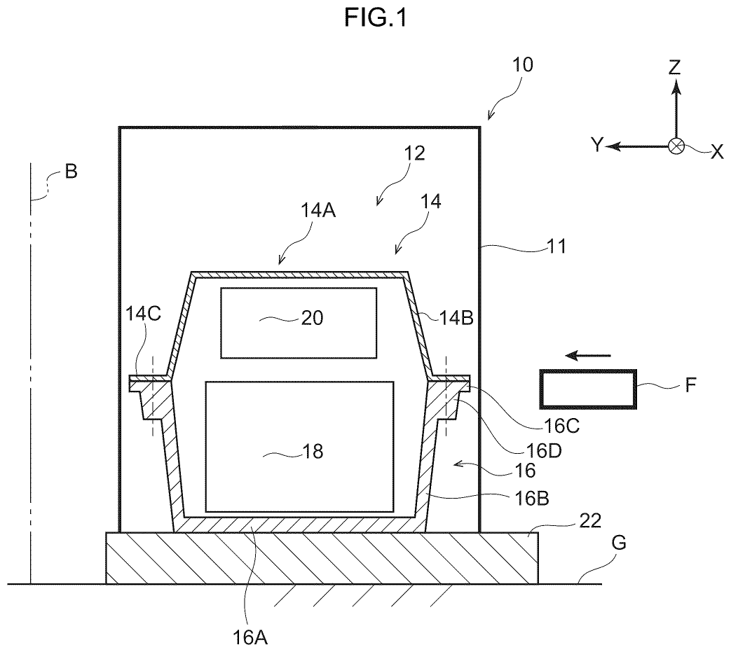

Hereinafter, an example of an embodiment of a power supply device according to the present disclosure will be described with reference to FIG. 1. As shown in FIG. 1, a “power supply device 10” according to the present embodiment is arranged at a predetermined location within the site of a building B, and is provided with a box-shaped outer case 11 configuring an outer shell and an “inner case 12” as a housing arranged inside the outer case 11.

Note that the arrow X shown in FIG. 1 indicates one side of the inner case 12 in a longitudinal direction, the arrow Y indicates one side of the inner case 12 in a transverse direction, and the arrow Z indicates one side of the inner case 12 in a height direction. Hereinafter, unless otherwise specified, the longitudinal direction of the inner case 12 is simply referred to as the longitudinal direction, the transverse direction of the inner case 12 is simply referred to as the transverse direction, and the height direction of the inner case 12 is simply referred to as the height direction. Note that among the longitudinal direction, the transverse direction, and the height direction, any one of these directions is orthogonal to the remaining two directions.

Specifically, the inner case 12 is provided with an “upper case 14” which configures an upper portion in the height direction and a “lower case 16” which configures a lower portion in the height direction.

The upper case 14 includes an upper wall portion 14A configuring an upper portion in the height direction, a side wall portion 14B configuring the outer periphery thereof, and a flange portion 14C extending from a peripheral edge portion of the side wall portion 14B at a lower side in the height direction, toward the outside of the inner case 12. Note that the side wall portion 14B is inclined to the outside of the inner case 12 so that the width in the longitudinal direction and the width in the transverse direction expand toward the lower case 16; that is, toward the lower side in the height direction.

Further, the lower case 16 is configured to include a lower wall portion 16A configuring the lower portion in the height direction thereof, a “side wall portion 16B” configuring the outer periphery thereof, and a “flange portion 16C” as an attachment portion extending from a peripheral edge portion at an upper side in the height direction of the side wall portion 16B toward the outside of the inner case 12. Note that the side wall portion 16B is inclined to the outside of the inner case 12 so that the width in the longitudinal direction and the width in the transverse direction expand toward the upper case 14; that is, toward the upper side in the height direction.

Furthermore, at the boundary portion between the side wall portion 16B and the flange portion 16C, a “thick-walled portion 16D” which protrudes toward the outside of the lower case 16 is provided so as to follow the peripheral edge portion at the upper side in the height direction of the side wall portion 16B, and in the lower case 16, the portion at which the thick-walled portion 16D is provided is the thickest portion.

Furthermore, plural female screw portions (not shown), at which bolts (not shown) used for fastening the upper case 14 and the lower case 16 are engaged, are formed in the thick-walled portion 16D. Further, in a state in which the flange portion 14C of the upper case 14 is placed on the flange portion 16C of the lower case 16, the upper case 14 is attached to the lower case 16 by engaging a bolt from the upper side in the height direction with the female screw portion of the thick-walled portion 16D.

Note that the thick-walled portion 16D need not be provided at a part of the lower case 16 where no female screw portion is formed, or need not be provided in the part of the lower case 16 at the side of the building B. Further, plural “storage battery modules 18” as storage batteries and a control device 20 are stored inside the inner case 12 configured as described above.

The storage battery module 18 is configured by plural lithium-ion battery cells (not shown), and is arranged in series in the longitudinal direction inside the lower case 16. These storage battery modules 18 are electrically connected to a connection part (not shown) provided in the outer case 11, and electrical power can be supplied to various loads in the building B via the connection part.

Furthermore, the upper surface of the flange portion 16C is positioned at the upper side in the height direction relative to the lower surface of the storage battery module 18.

Further, the control device 20 is positioned inside the upper case 14, and is supported by the lower case 16 via a support frame (not illustrated). The control device 20 controls the storage battery module 18 to supply the electric power stored in the storage battery module 18 to a load in the building B, and the storage battery module 18 can be controlled to be charged with the electric power supplied from an external power source (not shown) connected to the power supply device 10.

Note that the power supply device 10 configured as described above is supported by the ground G via a base 22.

### Mechanism and Effects of Present Embodiment

Next, the mechanism and effects of the present embodiment will be described.

In the present embodiment, plural storage battery modules 18 are housed inside an inner case 12 provided with an upper case 14 and a lower case 16.

Incidentally, when the inner case 12 is installed outdoors, it is conceivable that an impact load from a flying object F during rough weather such as a typhoon will be input to the lower case 16. At this time, if the thickness of the lower case 16 is uniform, it is conceivable that stress will be concentrated at the boundary portion between the lower wall portion 16A and the side wall portion 16B of the lower case 16, whereby cracks are generated, and rainwater or the like will enter the inside of the lower case 16 via the cracks.

In the present embodiment, the lower case 16 has a flange portion 16C provided at an upper side of the side wall portion 16B, and the upper case 14 is attached to the flange portion 16C in a state of being disposed at an upper side relative to the bottom surface of the storage battery module 18.

Further, a thick-walled portion 16D which protrudes toward the outside of the lower case 16 is provided at the boundary portion between the side wall portion 16B and the flange portion 16C.

For this reason, in the present embodiment, when an impact load from a flying object F during rough weather such as a typhoon is input to the lower case 16, there is a tendency for stress to be concentrated at the boundary portion between the side wall portion 16B and the thick-walled portion 16D. As a result, the reliability with which the side wall portion 16B of the lower case 16 deforms at an upper side relative to the bottom surface of the storage battery module 18 as a result of the impact load is improved, and ingress of rainwater or the like into the inside of the lower case 16 via a crack in the lower case 16 caused by an impact load can be suppressed.

Furthermore, in the present embodiment, the side wall portion 16B of the lower case 16 is inclined to the outside of the lower case 16 on progression toward the upper case 14. For this reason, the distance between the thick-walled portion 16D provided in the lower case 16 and the storage battery module 18 is secured, and when the vicinity of the thick-walled portion 16D of the lower case 16 is deformed owing to an impact load from the flying object F, contact between the lower case 16 and the storage battery module 18 can be suppressed.

As described above, in the power supply device 10 according to the present embodiment, it is possible to reduce the influence on the storage battery module 18 of an impact load from a flying object during rough weather such as a typhoon.

What is claimed is:

1. A power supply device, comprising:
a housing including an upper case and a lower case; and
a plurality of storage batteries housed in the housing,
the lower case comprising:
a side wall portion configuring an outer periphery of the lower case;
an attachment portion that is provided at an upper side of the side wall portion, and that is attachable to the upper case in a state in which the upper case is disposed at an upper side relative to a bottom surface of the storage batteries; and
a thick-walled portion protruding toward an outer side of the lower case at a boundary portion between the side wall portion and the attachment portion.

2. The power supply device of claim 1, wherein the side wall portion inclines toward the outer side of the lower case on progression toward the upper case.

3. The power supply device of claim 1, wherein:
the attachment portion comprises a flange portion extending toward the outer side of the lower case from a peripheral edge portion at an upper side of the side wall portion,
the thick-walled portion is provided along the peripheral edge portion, and
a portion at which the thick-walled portion is provided is a thickest portion of the lower case.
